(19) United States
(12) Patent Application Publication
(10) Pub. No.: US 2025/0036901 A1
(43) Pub. Date: Jan. 30, 2025

(54) INSPECTION APPARATUS, CONTROL METHOD FOR INSPECTION APPARATUS, AND INSPECTION SYSTEM

(71) Applicant: CANON KABUSHIKI KAISHA, Tokyo (JP)

(72) Inventor: KENICHIROU HARUTA, Chiba (JP)

(21) Appl. No.: 18/786,233

(22) Filed: Jul. 26, 2024

(30) Foreign Application Priority Data
Jul. 28, 2023 (JP) 2023-123787

(51) Int. Cl. G06K 15/02; B41F 7/02; B41F 33/00; B41J 2/21; G03G 15/00; G06T 7/00; G06T 7/90

(52) U.S. Cl. CPC G06K 15/027; G06K 15/1878; G06T 7/0008; G06T 7/001; G06T 7/90; B41F 7/02; B41F 33/0036; B41J 2/2135; G03G 15/5016; G03G 15/5062; G06T 2200/24; G06T 2207/10024; G06T 2207/20092

(57) ABSTRACT

An image printed on a pre-printed sheet on which information of a specific color is printed in advance and the information are scanned. the specific color included in scanned and obtained image data is removed, and an image obtained after the specific color is removed is inspected based on a reference image.

### BACKGROUND

### Field of the Disclosure

The present disclosure relates to an inspection apparatus, a control method for the inspection apparatus, and an inspection system.

### Description of the Related Art

In recent years, an inspection system has been proposed in which a sheet printed by a printing apparatus (hereinafter, which will be referred to as a printed sheet) can be inspected by a product check apparatus during sheet conveyance. In the inspection on the printed sheet, the product check apparatus scans an image on the conveyed printed sheet to determine whether or not the printing on the printed sheet is normal based on an image analysis on the scanned image. The product check apparatus can detect a printing failure or a color drift. The product check apparatus may also print an image on a pre-printed sheet on which an image is printed in advance (hereinafter, the image printed in advance is referred to as a pre-printed image) to perform the inspection on the image. According to Japanese Patent Laid-Open No. 2007-310567, when the image inspection is performed on the pre-printed sheet, to confirm whether or not print data is printed without fail, mask data is generated based on the print data, and a surrounding area of the print data is set as an inspection area.

However, according to Japanese Patent Laid-Open No. 2007-310567, since an inspection area is limited to the surrounding area of the print data, an issue occurs that an entire sheet is not to be inspected.

### SUMMARY

An inspection apparatus according to embodiments of the present disclosure includes a scanning unit configured to scan an image printed on a pre-printed sheet on which information of a specific color is printed in advance and to scan the information, a processing unit configured to remove the specific color included in image data that is scanned and obtained by the scanning unit, and an inspection unit configured to inspect, based on a reference image, an image obtained after the specific color is removed by the processing unit.

Further features of the present disclosure will become apparent from the following description of exemplary embodiments with reference to the attached drawings.

### BRIEF DESCRIPTION OF THE DRAWINGS

FIG. 1 is a block diagram of an entire inspection system including an image processing apparatus according to an embodiment.

FIG. 2 is a block diagram illustrating a functional arrangement of the image processing apparatus according to the embodiment.

FIG. 3 is a flowchart illustrating a processing procedure of product check processing performed in the image processing apparatus according to the embodiment.

FIG. 4 is a flowchart illustrating a processing procedure of inspection setting processing performed in the image processing apparatus according to the embodiment.

FIG. 5 is a flowchart illustrating a processing procedure of the inspection execution processing performed in the image processing apparatus according to the embodiment.

FIG. 6 illustrates an example of a result display screen according to the embodiment.

FIG. 7 illustrates an example of a display screen according to the embodiment.

FIG. 8 illustrates an example of the display screen according to the embodiment.

FIG. 9 illustrates an example of the display screen according to the embodiment.

FIG. 10 is a detailed flowchart of a LUT generation processing according to the embodiment.

FIGS. 11A and 11B are image diagrams illustrating an example of three- dimensional LUT processing according to the embodiment.

FIGS. 12A to 12C illustrate an example in which a designated color is removed according to the embodiment.

FIGS. 13A and 13B illustrate an example of parameters used for designated color removal according to the embodiment.

FIGS. 14A to 14D illustrate sample images before and after processing according to the embodiment.

FIG. 15 is a flowchart illustrating a processing procedure of the inspection setting processing performed in the image processing apparatus according to an embodiment.

FIGS. 16A to 16C illustrate examples of the display screen according to the embodiment.

FIG. 17 is a flowchart illustrating a processing procedure of the inspection setting processing performed in the image processing apparatus according to an embodiment.

### DESCRIPTION OF THE EMBODIMENTS

Hereinafter, embodiments of the present disclosure will be described in detail with reference to the attached drawings. It is noted that the following embodiments are not intended to limit the present disclosure, and also all combinations of features described in the present embodiment are not necessarily needed to solutions of the present disclosure. It is noted that identical reference numerals are allocated to identical components, and descriptions thereof will be omitted.

### First Embodiment

### Configuration of Inspection System

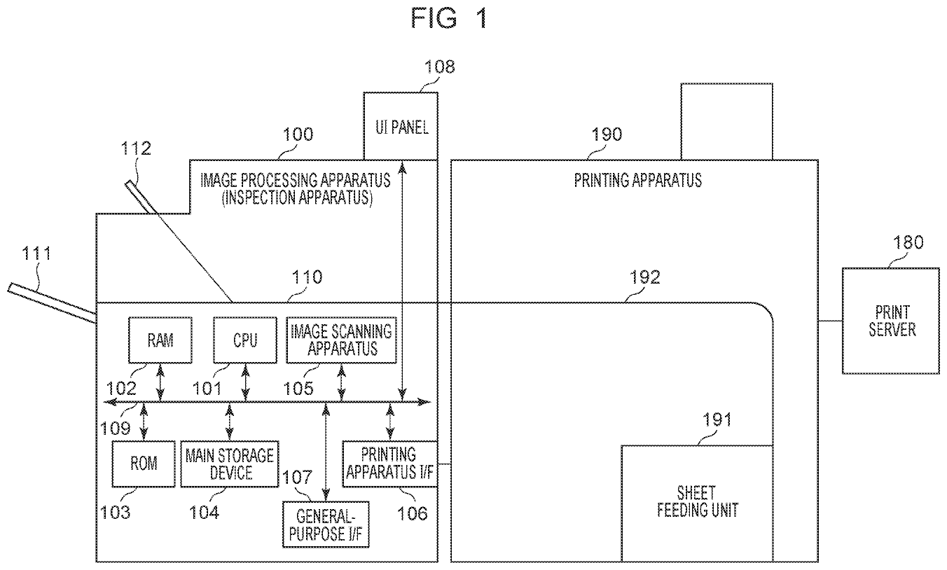

Hereinafter, a first embodiment of the present disclosure will be described. First, with reference to FIG. 1, a configuration example of an entire inspection system will be described which includes an image processing apparatus (inspection apparatus) 100 according to the present embodiment and which is configured to output a printed product and perform an inspection.

The inspection system according to the present embodiment includes at least the image processing apparatus 100 and a printing apparatus 190. A print server 180 may be included in the inspection system. The print server 180 has a function of generating a print job of an original document to be printed and inputting the print job to the printing apparatus 190. A plurality of external apparatuses which are not illustrated in the drawing may be communicably connected to the print server 180 via a network, and the print server 180 may receive print job generation requests, print data, and the like from these external apparatuses. The print server 180 can also perform raster image processor (RIP) processing for a reference image. Specifically, in the RIP processing for the reference image, an image is generated by converting a resolution, for example, from 600 dpi to 300 dpi, and in the RIP processing for the print data, an image is generated without reducing the resolution.

The printing apparatus 190 has a function of forming an image on a recording medium (printing sheet) based on the print job input from the print server 180. An apparatus based on an offset printing method, an electrophotographic method, an ink-jet method, or the like can be applied as the printing apparatus 190. According to the present embodiment, the description will be provided while the printing apparatus based on the electrophotographic method is assumed, but the present disclosure is not intended to be limited. The printing apparatus 190 includes a sheet feeding unit 191, and a user sets the printing sheet in the sheet feeding unit 191 in advance. When the print job is input, the printing apparatus 190 forms an image on a front side or both sides while conveying the printing sheet set in the sheet feeding unit 191 along a sheet conveying path 192, and conveys the sheet to the image processing apparatus 100.

The image processing apparatus 100 of the present embodiment executes inspection processing of checking whether an image defect is present or absent with regard to the sheet (also referred to as paper, a recording medium, or the like), that is, the printed product, on which the image is formed by the printing apparatus 190 and which is conveyed through the sheet conveying path 192. In other words, the image processing apparatus 100 functions as an inspection apparatus. It is noted that overall processing of inspecting whether the image defect is present or absent will be herein referred to as inspection processing. Processing, which is included in the inspection processing, of detecting respective image defects of a plurality of types will be referred to as defect detection processing (or, simply referred to as detection processing). The image processing apparatus 100 includes therein a central processing unit (CPU) 101, a random access memory (RAM) 102, a read-only memory (ROM) 103, a main storage device 104, and an image scanning apparatus 105. The image processing apparatus 100 also includes a printing apparatus interface (I/F) 106, a general-purpose interface (I/F) 107, a user interface (UI) panel 108, and a main bus 109. The image processing apparatus 100 further includes a sheet conveying path 110 for the printed product which is connected to the sheet conveying path 192 of the printing apparatus 190, an output tray 111 for a printing result which has passed the inspection, and an output tray 112 for a printed product from which a defect has been discovered and which has been rejected in the inspection. It is noted that classification of the printed products may be more detailed classification in addition to the two types of pass and rejection in the image inspection.

The CPU 101 is a processor configured to control an entirety in the image processing apparatus 100. The RAM 102 functions as a main memory, a work area, or the like of the CPU 101. The ROM 103 stores a group of programs executed by the CPU 101. The main storage device 104 stores application executed by the CPU 101, data used for image processing, and the like. The image scanning apparatus (scanner) 105 can scan one side or both sides of the printed product conveyed from the printing apparatus 190 on the sheet conveying path 110 to be obtained as image data. Specifically, the image scanning apparatus 105 scans one side or both sides of the conveyed printed product by using one or more scanning sensors provided in the vicinity of the sheet conveying path 110. The scanning sensor may be provided on only one side, or may also be provided on both sides including a front side and a back side of the conveyed printed product to scan both sides at the same time. When the scanning sensor is provided on only one side, after scanning one side, the scanning sensor may be caused again to scan the other side by flipping the front and back of the conveyed printed product using a two-sided sheet conveying path which is not illustrated in the drawing in the sheet conveying path 110.

The printing apparatus I/F 106 is connected to the printing apparatus 190, and can synchronize processing timing of the printed product with the printing apparatus 190 and communicate mutual operating statuses with each other.

The general-purpose I/F 107 is a serial bus interface such as a universal serial bus (USB) or IEEE1394 with which the user can take out data such as a log or take any data into the image processing apparatus 100. The UI panel 108 is, for example, a liquid crystal display (display unit). The UI panel 108 functions as a user interface of the image processing apparatus 100 and displays a current situation or setting to inform the user. The UI panel 108 can be a touch panel liquid crystal display and accept an instruction from the user when a displayed button is operated by the user.

The main bus 109 connects each unit of the image processing apparatus 100. Each part inside the image processing apparatus 100 or the inspection system can be caused to operate by an instruction from the CPU 101 through the main bus 109. For example, the sheet conveying path 110 can be moved in synchronization, or according to an inspection result, it is possible to switch the path as to whether the printed product is conveyed to the output tray 111 for the passed printed product or the output tray 112 for the rejected printed product. In addition to the CPU, a graphics processing unit (GPU) may also be included.

The image processing apparatus 100 according to the present embodiment executes inspection processing which will be described below based on the image data obtained by scanning the printed product by the image scanning apparatus 105 while the printed product conveyed from the printing apparatus 190 is conveyed in the sheet conveying path 110. As a result of the inspection processing, when the printed product has passed the inspection, the printed product is conveyed to the output tray 111 for the passed printed product, and when the printed product has not passed the inspection, the printed product is conveyed to the output tray 112 for the rejected printed product. In this manner, only the printed products with assured quality can be collected in the output tray 111 as the printing results for delivery.

### Product Check Overall Flow

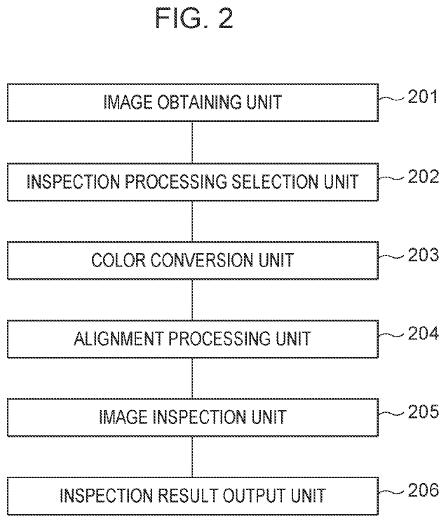

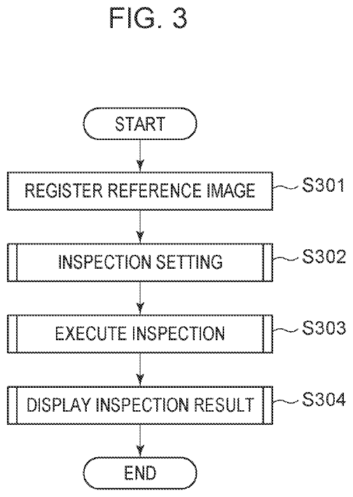

Next, an overall flow from registration operation before start of an inspection to execution of the inspection will be described with reference to FIG. 2 and FIG. 3. The processing described below is realized, for example, when the CPU 101 reads out a program stored in the ROM 103 onto the RAM 102 to execute the program. Hereinafter, step number of each processing is denoted by a number following “S”. FIG. 2 is a block diagram illustrating a functional arrangement of the image processing apparatus 100. FIG. 3 is a flowchart illustrating a processing procedure of the inspection processing.

In step S301, an image obtaining unit 201 registers an image set as a reference image of the inspection.

The image obtaining unit 201 obtains a reference image (reference image data) from the RAM 102 or the main storage device 104. It is noted however that the reference image data is stored in the RAM 102 or the main storage device 104 in advance. Image data after RIP processing of analyzing the print job to generate image data is set as the reference image.

Next, in step S302, an inspection processing selection unit 202 performs setting on various inspection parameters such as an inspection level and on whether or not the inspection is to be performed on a pre-printed sheet in accordance with inspection settings by the user.

It is noted that details of step S302 according to the present embodiment will be described below.

Next, in step S303, the image obtaining unit 201 obtains an inspection target image by causing the image scanning apparatus 105 to scan the printed product conveyed from the printing apparatus 190. It is noted that a configuration may be adopted in which the inspection target image is scanned by the image scanning apparatus 105 in advance, and scanned data held in the main storage device 104 is obtained.

Furthermore, when the inspection on the pre-printed sheet is selected in step S302, a color conversion unit 203 executes color correction processing which will be described below on the inspection target image.

An alignment processing unit 204 and an image inspection unit 205 then perform alignment of the inspection target image after the color correction processing and the reference image and also execute the defect detection processing. Details of step S303 in the present embodiment will be described below.

In step S304, an inspection result output unit 206 generates an inspection result to be displayed on the UI panel 108, and the processing ends.

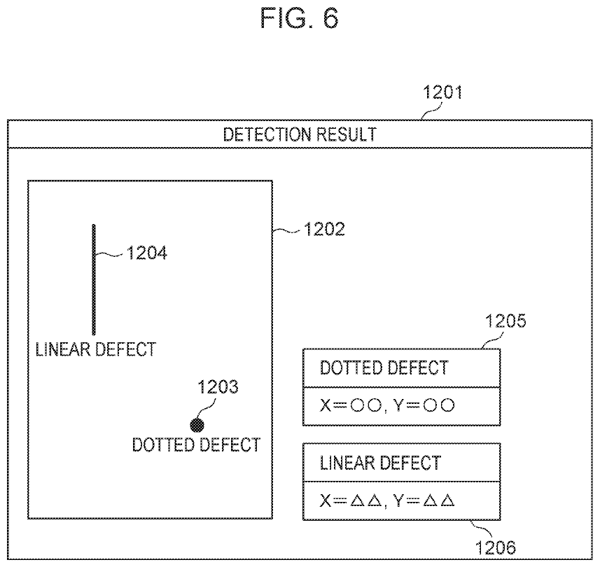

FIG. 6 illustrates an example of a result display screen according to the present embodiment. A broad overview 1202 of an inspection correspondence image is displayed on a UI screen 1201. A defect 1203 is determined as a dotted defect, and a phrase “dotted defect” is also displayed in the vicinity of the defect 1203. A defect 1204 is determined as a linear defect, and a phrase “linear defect” is also displayed in the vicinity of the defect 1204. Furthermore, as indicated by reference numerals 1205 and 1206, coordinates of the respective defects may also be displayed.

The overall flow from the registration operation before the start of the inspection to the execution of the inspection according to the present embodiment has been described above.

### Inspection Setting Processing

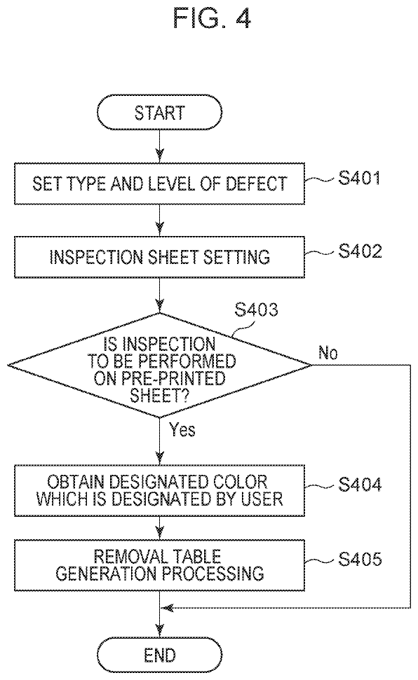

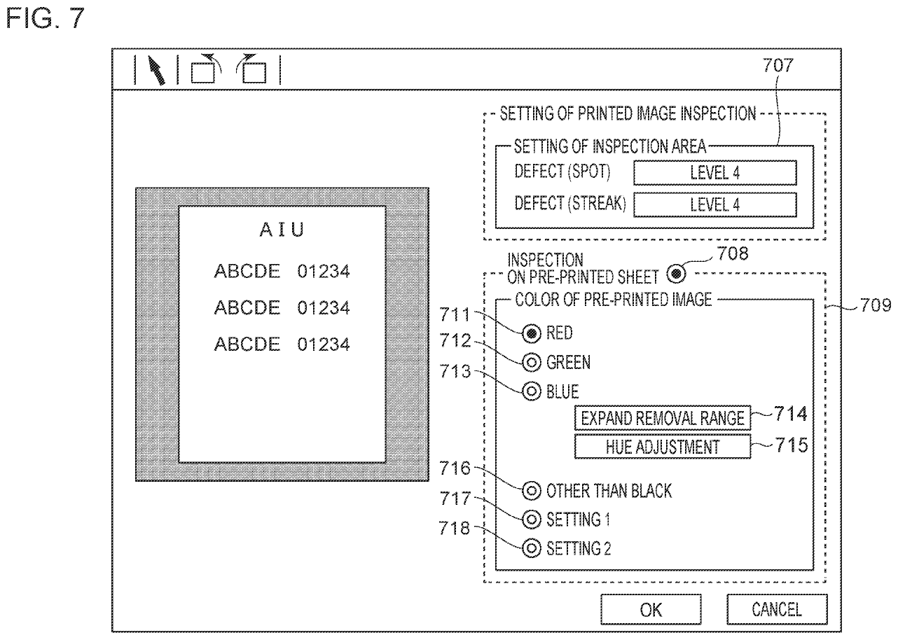

Next, with reference to FIG. 4 and FIG. 7, a processing procedure of the inspection setting in S302 according to the present embodiment will be described. FIG. 4 is a flowchart illustrating the processing procedure of the inspection setting. FIG. 7 illustrates an example of a UI designed to set the inspection setting.

In step S401, the inspection processing selection unit 202 sets a detection item for which a defect is detected in a printed image inspection of an UI 707 and a detection level thereof. The detection item in the printed image inspection refers to an item related to a feature of the defect desired to be detected when the printed product is inspected, and is, for example, a dotted defect (spot defect) or a linear defect (streak defect). The detection level refers to a parameter set in stages with regard to from what size the defect is to be determined for each detected defect feature. For example, there are five stages from level 1 to level 5, and a defect with a thinner and smaller size can be detected at level 5 as compared with level 1. In addition, levels can be set for respective inspection items as in a case where the inspection level 5 is set for the spot, and the inspection level 4 is set for the streak. The UI 707 represents that the user has selected level 4 as the inspection level setting for the defect (spot) and level 4 as the inspection level setting for the defect (streak).

In step S402, the inspection processing selection unit 202 performs setting of an inspection sheet. The setting of the inspection sheet indicates whether or not the inspection sheet is a pre-printed sheet on which an image is printed in advance. According to the present embodiment, a case will be described where a specific color of a pre-printed sheet on which information of the specific color is printed in advance is designated as a designated color. Then, by removing the designated color from the pre-printed image, the inspection in comparison with the reference image is realized without obtaining information of the image printed on the pre-printed sheet.

A UI 709 illustrates an example where the inspection sheet is a pre-printed sheet as an example. By selecting a radio button 708, the user notifies the inspection processing selection unit 202 that the inspection sheet is the pre-printed sheet.

In step S403, the inspection processing selection unit 202 determines whether or not the inspection is an inspection on the pre-printed sheet depending on whether or not the radio button 708 on the UI 709 is selected. When it is determined that the inspection is an inspection on the pre-printed sheet, the flow proceeds to step S404. When it is determined that the inspection is not an inspection on the pre-printed sheet, the processing ends.

In step S404, the inspection processing selection unit 202 accepts a color of the pre-printed image from the user. For example, a radio button 711 can be selected to set red as the designated color. A radio button 712 can be selected to set green as the designated color. A radio button 713 can be selected to set blue as the designated color. It is noted that colors other than the three colors of red, blue, and green may also be selected as types of colors that can be designated. When the inspection processing selection unit 202 accepts a selection from the user on a color for which designated color removal is desired to be performed, the inspection processing selection unit 202 accepts press of any of the radio button 711 to set red as the designated color, the radio button 712 to set green as the designated color, and the radio button 713 to set blue as the designated color to accept an instruction on the color desired to be removed. According to the present embodiment, a case will be described where the user has selected the radio button 711 to set red as the designated color. It is noted that a plurality of colors may be selected.

In step S404, the inspection processing selection unit 202 stores the removing color selected by the user in the RAM 102 as a setting value. In addition to the above, in step S404, it is possible to select more detailed setting tuning on the designated color removal. For example, such setting can be performed that after the designated color is decided, a removal range of the designated color is expanded, and a color across a wider range can be removed. Details of the more detailed setting tuning on the designated color removal will be described below. With this configuration, even when the designated color is a color difficult to be designated or when a color at an edge end changes due to an influence at the time of printing or scanning, it becomes easy to perform the setting.

In step S405, the inspection processing selection unit 202 calculates a three-dimensional look-up table (LUT) with which an accepted designated color component can be removed. Details thereof will be described below.

The processing procedure of the inspection setting according to the present embodiment has been described above.

### Inspection Execution Processing

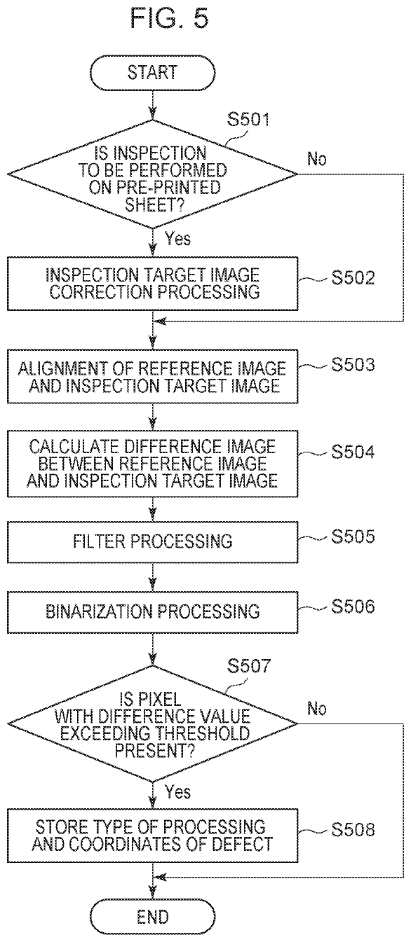

Next, with reference to FIG. 5, a processing procedure of inspection execution processing executed in step S303 by the color conversion unit 203, the alignment processing unit 204, and the image inspection unit 205 according to the present embodiment will be described. FIG. 5 is a flowchart illustrating the processing procedure of the inspection execution processing in step S303.

First, in S501, the color conversion unit 203 determines whether or not the inspection is an inspection on the pre-printed sheet. Whether or not the inspection is an inspection on the pre-printed sheet is determined depending on whether or not the radio button 708 indicating the inspection on the pre-printed sheet is pressed in step S402. When it is determined that the present inspection is an inspection on the pre-printed sheet, the flow shift to step S502, and the color conversion unit 203 carries out correction processing on the pre-printed sheet. When it is determined that the present inspection is not an inspection on the pre-printed sheet, the color conversion unit 203 does not correct the inspection image, and the flow shift to step S503.

In S502, the color conversion unit 203 performs the correction processing on the inspection target image by using the LUT generated in step S405. Details of the correction processing will be described below.

In S503, the alignment processing unit 204 performs alignment of the reference image and the inspection target image. Herein, a method in related art such as an affine transformation has been proposed for the alignment.

In S504, the image inspection unit 205 obtains a difference image between the reference image and the inspection target image, and the flow proceeds to S505. Herein, the difference image refers to an image obtained by, for example, comparing the reference image with the inspection target image for each pixel and obtaining a difference value between pixel values (for example, density values for each of R, G, and B) for each pixel.

In S505, the image inspection unit 205 executes filter processing to highlight a particular shape on the difference image obtained in S504.

In S506, the image inspection unit 205 executes binarization processing on the difference image having been subjected to the highlighting processing such that a binary value becomes “1” when the difference value exceeds a threshold, and the binary value becomes “0” when the difference value is equal to or lower than the threshold.

In S507, the image inspection unit 205 determines whether a pixel in which the difference value exceeds the threshold and the binary value becomes “1” is present in the image on which the binarization processing is performed. When the pixel is present, the flow proceeds to S508, and when the pixel is absent, it is assumed that a defect position is absent, and the present processing ends. In S508, it is assumed that the defect position is present, and the image inspection unit 205 stores a type of the defect detection processing with which the defect position is detected and coordinates of the defect position in association with each other. Then, the processing ends.

### Three-Dimensional LUT Generation Method for Designated Color Removal

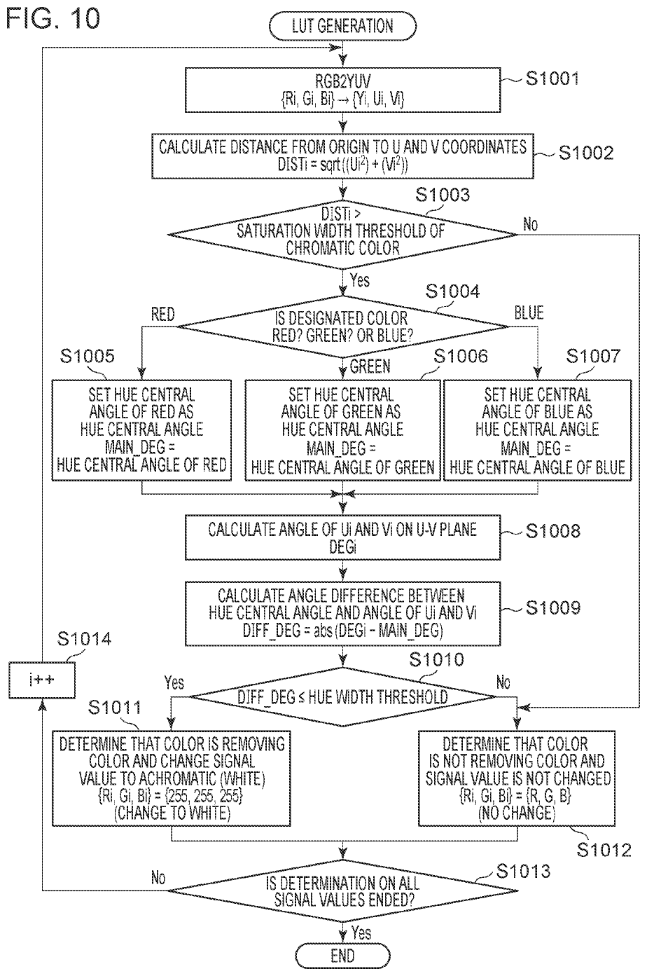

A flow of calculating a three-dimensional LUT with which a designated color component accepted by the inspection processing selection unit 202 can be removed will be illustrated with reference to FIG. 10. This flow is carried out by the inspection processing selection unit 202 and realized when the CPU 101 included in the image processing apparatus 100 executes a control program.

Data to be input includes R, G, and B on the output side of the three-dimensional LUT, and signal values of all tables (according to the present embodiment, 16×16×16 tables since the values are increments of 15) are processed. In addition, a saturation width threshold, a hue central angle, and a hue width threshold of each designated color are input as parameters of the processing. It is noted that the three-dimensional LUT with which the processing is performed and the input parameters used for the processing are saved in the ROM 103. The input parameters will be described below.

In step S1001, when any of red, green, and blue is designated as the designated color, Ri, Gi, and Bi that have been input are converted from an RGB color space into a color space of a luminance and a color difference (for example, a YUV color space). The conversion from RGB into YUV is based on following expressions.

$$Yi = 0.299 \times Ri + 0.587 \times Gi + 0.114 \times Bi$$

$$Ui = - 0.169 \times Ri - 0.331 \times Gi + 0.50 \times Bi$$

$$Vi = 0.5 \times Ri - 0.419 \times Gi - 0.081 \times Bi$$

It is noted that “i” denotes a LUT number in which the processing is performed among all the tables. Herein, “i” takes a value from 0 to 4095.

In step S1002, a distance from the origin (0, 0) to (Ui, Vi) values is calculated based on the converted color difference signal (Ui and Vi among Yi, Ui, and Vi). As a calculation expression, for example, the calculation is performed by the following expression.

$$DISTi = sqrt ( ( Ui \times Ui ) + ( Vi \times Vi ) )$$

Herein, the calculated value is referred to as a saturation value.

In step S1003, it is determines whether or not the calculated saturation value is a higher saturation or a lower saturation than a particular threshold (saturation value threshold). The saturation value threshold is preset and held in the ROM 103 as a parameter, and the determination is performed by using the value. It is noted that the saturation value threshold may be a different value for each of designated colors. When the calculated saturation value is higher than the saturation value threshold (in the case of the high saturation), the flow proceeds to step S1004, and when the calculated saturation value is lower than the saturation value threshold (in the case of the low saturation), the flow proceeds to step S1012.

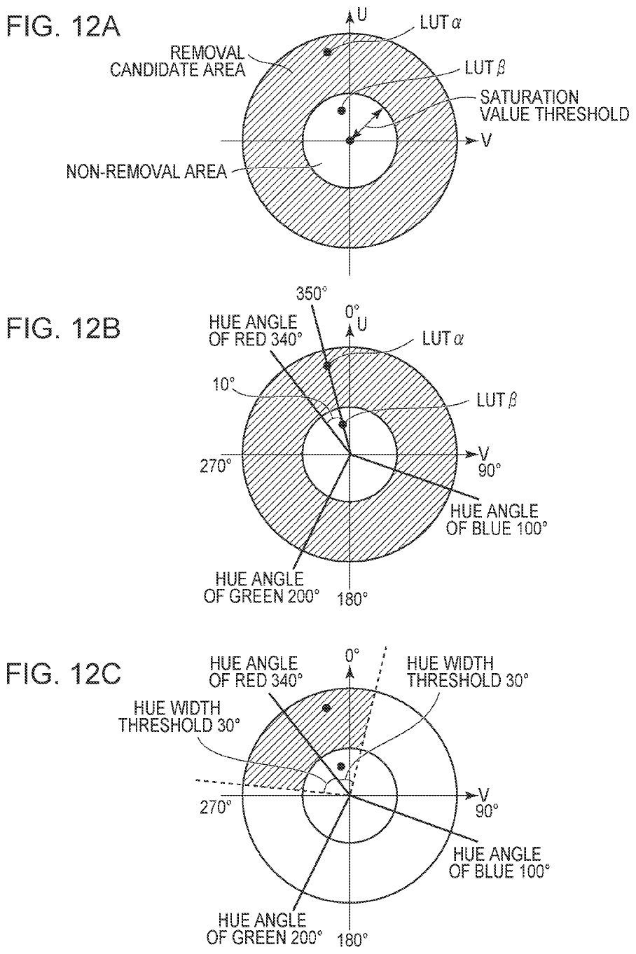

At this point in time, when the saturation value of the input signal value is on the low saturation side relative to the saturation value threshold, it is determined that the removal is not performed. On the other hand, when the saturation value of the input signal value is on the high saturation side relative to the saturation value threshold, this is set as a removal candidate. Herein, since a color of the low saturation is not to be removed, it is possible to avoid removal of a color close to an achromatic color. A hatched patch area in FIG. 12A is set as a removal candidate. It is assumed that the input LUT which may be plotted at a point of LUTα is set as a removal candidate, and the input LUT which may be plotted at a point of LUTβ is not to be removed.

In step S1004, the flow branches depending on which color is a designated color accepted by the inspection processing selection unit 202 among red, green, and blue. When the designated color accepted by the inspection processing selection unit 202 is red, the flow proceeds to step S1005. When the designated color accepted by the inspection processing selection unit 202 is green, the flow proceeds to step S1006. When the designated color accepted by the inspection processing selection unit 202 is blue, the flow proceeds to step S1007.

In step S1005, step S1006, and step S1007, a hue central angle is set on a U-V plane of a reference of the color designated from among R, G, and B, respectively. As illustrated in FIG. 12B, while the origin on the U-V plane is set as a center, in a range with an apex side as 0° up to 359° clockwise, a hue angle of the reference of each color is preset and held as the parameter, and the value is used. For example, as illustrated in FIG. 12B, 340° is set for the hue central angle of red, 200° is set for the hue central angle of green, and 100° is set for the hue central angle of blue.

In step S1008, an angle (U and V hue angle) on the U-V plane is calculated based on the converted color difference signal (U and V among Y, U, and V). An example is illustrated where angles of 350° are calculated for both LUTα and LUTβ in FIG. 12B.

In step S1009, an angle difference (hue angle difference) between U and V hue angles of each LUT calculated based on the reference hue angle set in step S1005, step S1006, or step S1007 and the color difference signal converted in step S1008 is calculated by the following expression.

DIFF_DEG=|(U and V hue angle of each LUT)−(reference hue angle)|

For example, when the designated color accepted by the inspection processing selection unit 202 is red, an angle difference between the value set in step S1005 and the value calculated in step S1008 is calculated. When the designated color accepted by the inspection processing selection unit 202 is red, a reference hue angle value set in step S1005 is 340°, and the U and V hue angle calculated in step S1008 is 350° in both LUTα and LUTβ. For this reason, the hue angle difference becomes 10° in both LUTα and LUTβ. In step S1010, it is determined whether or not the hue angle difference calculated in step S1009 is higher than the hue width threshold of each color. When the hue angle difference is equal to or lower than the hue width threshold, the flow proceeds to step S1011, and when the hue angle difference is higher than the hue width threshold, the flow proceeds to step S1012. When the description is provided with reference to FIG. 12C, it is determined whether or not a point is within in an area on either side of the hue angle about the hue central angle of red by an angle corresponding to the hue width threshold. For example, when the hue width threshold is set as 30 degrees, a point within the hue angle of red at 340°±the hue width threshold at 30° is set as the removal range. Thus, a color gamut in the hue angle from 340°−30° (=310°) to 340°+30° (=370° (=10°)) is removed.

In step S1011, the RGB value of the LUT determined to be removed in step S1010 is changed to a signal value at which printing is not to be performed. For example, in the case of a luminance signal value, the value is changed to (R, G, B)= (255, 255, 255) indicating white.

In step S1012, the RGB value of the LUT determined not to be removed in step S1010 is not changed, and the input signal remains as it is.

In step S1013, the flow branches depending on whether or not all the LUTs (according to the present embodiment, 16×16×16 tables since the values are increments of 15) are inspected. When the inspection on all the signals is not ended, “i” is incremented to process the next LUT in step S1014. Then, the processing from step S1001 is carried out. When the determination on all the signals is ended, the processing ends.

In accordance with the above-described processing, it is possible to generate the LUT with which the input three-dimensional LUT can be removed according to the designated color component accepted by the inspection processing selection unit 202.

In addition, according to the present embodiment, the description has been provided on the configuration where the setting value is switched in the ranges of several stages on the UI that is also the configuration where the preset parameter value is used. However, a configuration may also be adopted where after a UI where the user can directly change the parameter is prepared, the parameter value can be directly adjusted.

### Adjustment of Removal Range

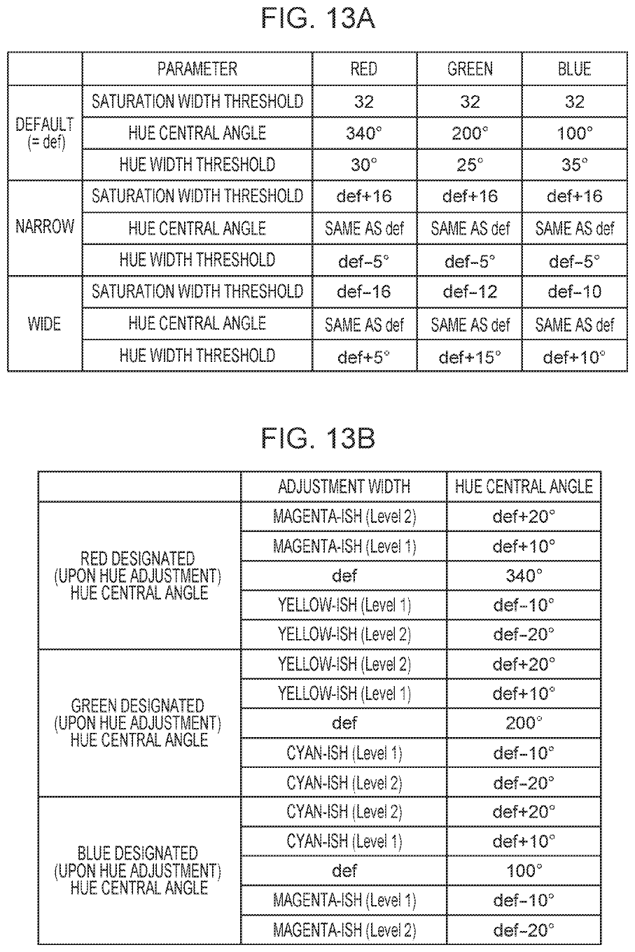

Parameter examples at the time of designation of “expand removal range” denoted by reference numeral 714 in step S403 are illustrated in a mode where the removal range is wide in FIG. 13A. Values are held with which a wider range than that of the default can be removed. By setting the saturation width threshold when red, green, or blue is designated as a value on an achromatic color side relative to the default, a coefficient is set with which an area farther to the achromatic color side can be removed. In addition, by setting the hue width threshold when red, green, or blue is designated to be a wider hue than that of the default, a coefficient is set with which an area farther to another hue side can be removed. The hue central angle is not changed from the default.

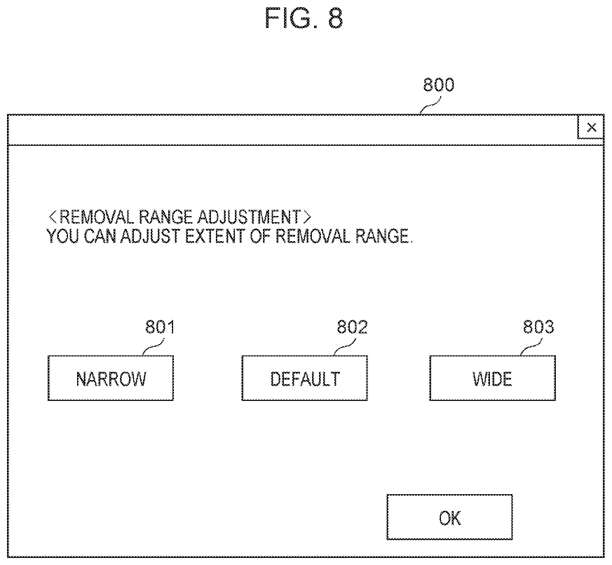

As a method for the designation by the user, the user can perform the setting using a UI 800 of FIG. 8.

For example, when a button 801 is selected, it is possible to select a parameter with the removal range narrower than that of the default. When a button 803 is selected, it is possible to select a parameter with the removal range wider than that of the default.

It is noted that with regard to the parameters described herein, the saturation width threshold is used in step S1003 to perform the processing, the hue central angle is used in steps S1005, S1006, and S1007 to perform the processing, and the hue width threshold is used in step S1010 to perform the processing.

### Hue Adjustment

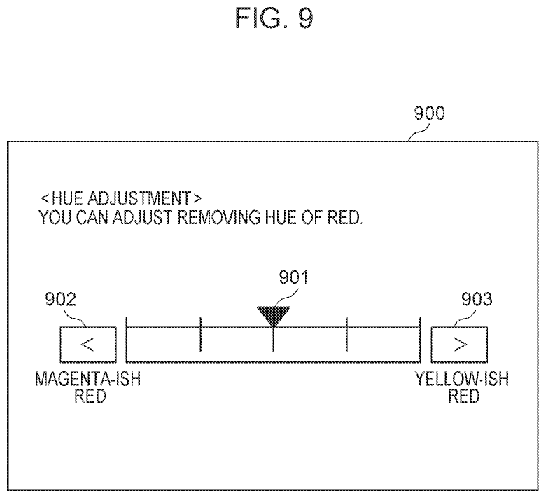

Parameter examples at the time of designation of “hue adjustment” denoted by reference numeral 715 in step S403 are illustrated in FIG. 13B. The hue central angle is changed relative to that of the default. For example, when the designated color is red, the hue central angle can be change in several levels to be magenta-ish or yellow-ish relative to the default hue central angle. As a method for the designation by the user, the setting can be performed using the UI in FIG. 9 described above. For example, after red is selected as the designated color using the radio button 711, when the hue adjustment mode 715 is selected, a hue adjustment setting UI 900 illustrated in FIG. 9 is displayed. Even when red is selected, it is possible to adjust a hue of the color to be removed such as magenta-ish red or yellow-ish red. For example, when magenta-ish red is desired to be removed, a button 902 is pressed to set the removing hue towards the magenta side. On the other hand, yellow-ish red is desired to be removed, a button 903 is pressed to set the removing hue towards the yellow side. The adjusted setting is confirmed by a mark denoted by reference numeral 901.

It is noted that with regard to the parameters described herein, the hue central angle is used in steps S1005, S1006, and S1007 to perform the processing.

According to the present embodiment, the case has been described where red is designated, but the setting can also be performed in the case of blue or green, and it is possible to perform the adjustment towards a color direction configuring the designated color.

In addition, “expand removal range” denoted by reference numeral 714 and “hue adjustment” denoted by reference numeral 715 can be independently adjusted. Only either one of the settings can be designated, and adjustments of both settings can be executed together.

In addition, designated colors that are designated in the past can be stored and set. For example, with a radio button 717, the color designated in the last inspection, the setting of the hue adjustment, and the setting of the removal range can be selected. Various settings of the removing color in the last inspection are stored in the main storage device 104. Similarly, it goes without saying that a radio button 718 is for the saved setting information of the removing color designated by the user.

When a radio button 716 “other than black” is selected, chromatic colors other than black are all to be removed.

### Designated Color Removal Processing

Next, three-dimensional LUT processing performed in the color conversion unit 203 and a method for the designated color removal when the designated color is designated will be described.

In the color conversion unit 203, when the designated color removal is performed, with respect to the image obtained by the image obtaining unit 201, R, G, and B images from which the pre-printed image on the pre-printed sheet is removed are generated from R, G, and B images having characteristics depending on a device.

Although various conversion methods have been proposed, as an example, conversion processing based on the three-dimensional LUT is illustrated.

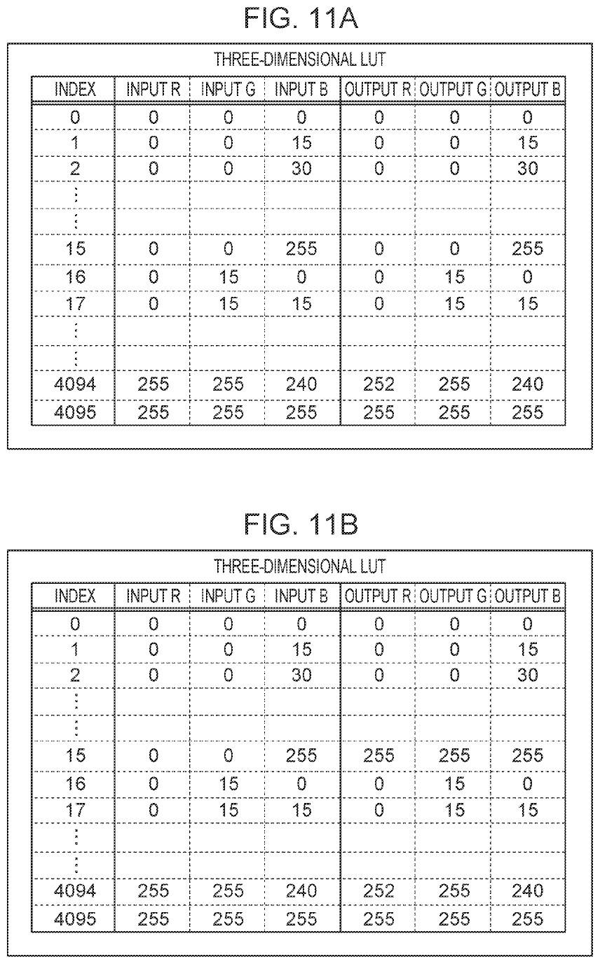

FIG. 11A illustrates an example of 4096 tables where thinning-out in increments of 15 is performed. An output R, an output G, and an output B which are output in response to an input R, an input G, and an input B which are input are decided as tables. For example, an output when an input is (0, 0, 15) is converted into (0, 0, 15). When the input is not a value in increments of 15, the output is obtained based on an interpolation calculation from an adjacent number.

When the designated color removal is to be carried out, the designated color removal is realized by changing the three-dimensional LUT used in the conversion processing performed in the color conversion unit 203. For example, R, G, and B signals on the output side of the three-dimensional LUT correspond to the designated color accepted by the inspection processing selection unit 202, the designated color removal is realized by converting content of this three-dimensional LUT. In other words, the color is removed by converting RGB of the designated color into (output R, output G, output B)=(255, 255, 255) to be set as values representing white in the luminance signal. The generation of the three-dimensional LUT may be performed each time in the setting values of the removing color and the removing area which are designated by the user, or the three-dimensional LUT may also be held for each of the designated colors.

For example, when blue (0, 0, 255) is designated, as illustrated in FIG. 11B, an output in response to the input of (0, 0, 255) in Index 15 is changed to (255, 255, 255).

### Description of Advantages

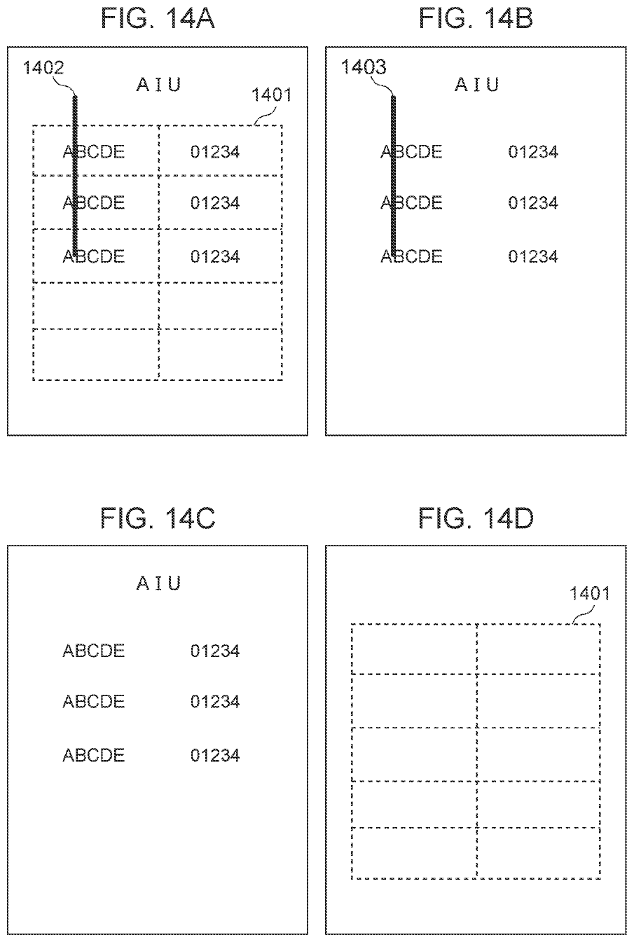

FIG. 14A illustrates an example of the inspection image obtained by scanning, by the image scanning apparatus 105, the recording medium in which print data is printed on the pre-printed sheet (FIG. 14D). Reference numeral 1401 denotes a pre-printed image printed in red. The streak 1402 is a black streak defect left at the time of the printing.

FIG. 14B illustrates an example of an inspection image obtained after the designated color (according to the present embodiment, red) is removed by the color conversion unit 203. A situation is observed where the pre-printed image 1401 is removed, but the black streak 1402 remains as denoted by reference numeral 1403.

FIG. 14C illustrates an example of the reference image. By performing alignment and comparison between the inspection image of FIG. 14B from which the designated color is removed and the reference image of FIG. 14C, it is possible to sense the streak 1403.

According to the present embodiment, the pre-printed image 1401 is removed and is not erroneously sensed as a defect. Even in the case of the inspection on the pre-printed sheet, the entire sheet can be correctly inspected. It is noted that FIG. 14D illustrates an example in which only the pre-printed image is printed on the pre-printed sheet.

### Advantages of the Present Embodiment

According to the present embodiment, even when the image is printed on the pre-printed sheet on which the pre-printed image is printed in advance to perform the inspection on the image, by designating the color of the pre-printed image and removing the color from the inspection image, it becomes possible to correctly inspect the entire sheet.

### Second Embodiment

According to the first embodiment, the method of designating the color of the pre-printed image by the user using the radio button on the UI has been described. According to a second embodiment, a method of scanning a pre-printed sheet on which a pre-printed image is printed at the time of inspection setting and designating a color of the pre-printed image by the user will be described. According to the present embodiment, by scanning the pre-printed image in advance, it becomes possible for the user not to select an erroneous color as the color of the pre-printed image.

Hereinafter, only a difference from the first embodiment will be described in detail.

### Inspection Setting Processing

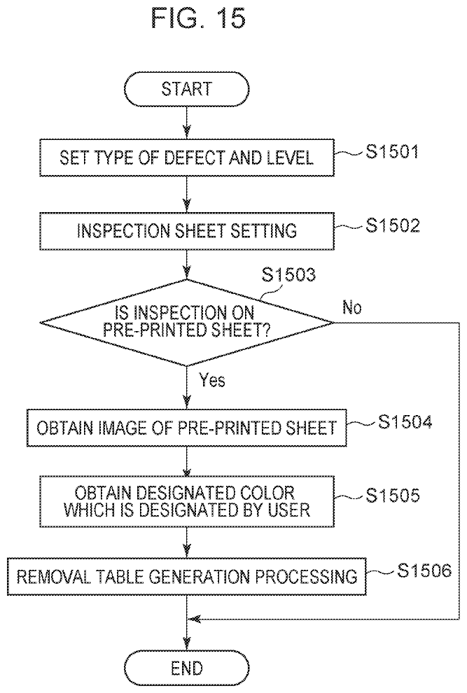

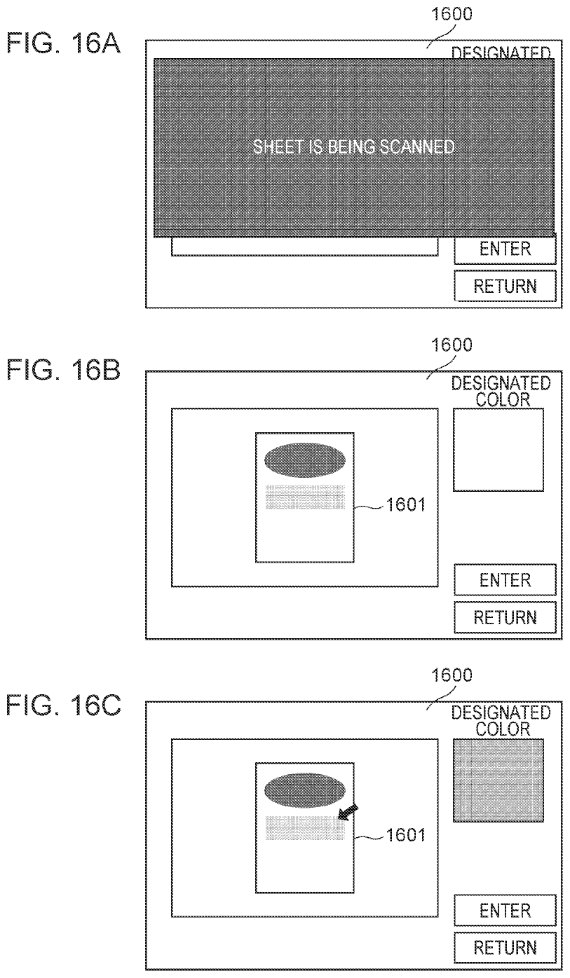

With reference to FIG. 15 and FIGS. 16A to 16C, the processing procedure of the inspection setting in S302 according to the present embodiment will be described. FIG. 15 is a flowchart illustrating the processing procedure of the inspection setting. FIGS. 16A to 16C illustrate examples of an UI used to set the color of the pre-printed image.

In step S1501, the inspection processing selection unit 202 sets a detection item for which a defect is detected in the printed image inspection on the UI 707 and a detection level thereof. In step S1502, the inspection processing selection unit 202 performs the setting of the inspection sheet. The setting of the inspection sheet indicates whether or not the inspection sheet is a pre-printed sheet on which an image is printed in advance. According to the present embodiment, by removing the pre-printed image, the inspection in comparison with the reference image is realized without obtaining information of the image printed on the pre-printed sheet. On the UI 709, selection of the radio button 708 by the user indicates that the pre-printed image is printed on the inspection sheet.

In step S1503, the inspection processing selection unit 202 determines whether or not the inspection is an inspection on the pre-printed sheet depending on whether or not the radio button 708 on the UI 709 is selected. When it is determined that the inspection is an inspection on the pre-printed sheet, the flow proceeds to step S1504. When it is determined that the inspection is not an inspection on the pre-printed sheet, the processing ends.

In step S1504, the inspection processing selection unit 202 displays a UI 1600 of FIG. 16A to scan the pre-printed sheet by the image scanning apparatus 105. Then, the pre-printed sheet set in the sheet feeding unit 191 is conveyed to the image processing apparatus 100 with nothing to be printed while the pre-printed sheet is conveyed along the sheet conveying path 192. The image scanning apparatus (scanner) 105 scans one side or both sides of the printed product conveyed from the printing apparatus 190 on the sheet conveying path 110 to be obtained as the pre-printed image.

In step S1505, the inspection processing selection unit 202 accepts a color of the pre-printed image from the user. The inspection processing selection unit 202 displays the image data scanned by the image scanning apparatus 105 on the UI 1600 of FIG. 16B (display control). Then, as illustrated in FIG. 16C, a position selected by the user from the displayed image is displayed as a designated color and obtained as the designated color.

In step S1506, the inspection processing selection unit 202 calculates the three-dimensional LUT with which the accepted designated color component can be removed. The processing procedure of the inspection setting according to the present embodiment has been described above.

### Advantages of the Present Embodiment

According to the present embodiment, by scanning, in advance, the pre-printed sheet on which the pre-printed image is printed in advance and designating the color of the pre-printed image from the scanned image, it becomes possible for the user not to select an erroneous color as the color of the pre-printed image.

### Third Embodiment

According to the second embodiment, the method of scanning the pre-printed sheet in advance on which the pre-printed image is printed in advance and manually designating the color of the pre-printed image from the scanned image has been described. According to a third embodiment, a method of automatically obtaining a color of the pre-printed image will be described.

According to the present embodiment, by scanning, in advance, the pre-printed sheet on which the pre-printed image is printed in advance and determining and designating the color of the pre-printed image from the scanned image, convenience of the user is improved. Hereinafter, only a difference from the first embodiment will be described in detail.

### Inspection Setting Processing

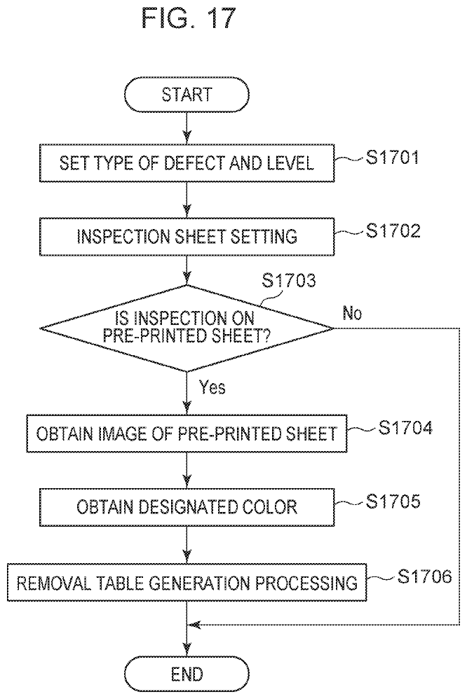

Next, with reference to FIG. 17, the processing procedure of the inspection setting in S302 according to the present embodiment will be described. FIG. 17 is a flowchart illustrating the processing procedure of the inspection setting.

In step S1701, the inspection processing selection unit 202 sets a detection item for which a defect is detected in the printed image inspection on the UI 707 and a detection level thereof. In step S1702, the inspection processing selection unit 202 performs the setting of the inspection sheet.

In step S1703, the inspection processing selection unit 202 determines whether or not the inspection is an inspection on the pre-printed sheet depending on whether or not the radio button 708 on the UI 709 is selected. When it is determined that the inspection is an inspection on the pre-printed sheet, the flow proceeds to step S1704. When it is determined that the inspection is not an inspection on the pre-printed sheet, the processing ends.

In step S1704, the printing apparatus 190 conveys the pre-printed sheet set in the sheet feeding unit 191 to the image processing apparatus 100 with nothing to be printed while conveying the pre-printed sheet along the sheet conveying path 192. The image scanning apparatus (scanner) 105 scans one side or both sides of the printed product conveyed from the printing apparatus 190 on the sheet conveying path 110 to be obtained as the pre-printed image.

In step S1705, the inspection processing selection unit 202 determines a color of the pre-printed image. The binarization processing with a predetermined luminance set as a threshold is performed on the obtained pre-printed image to generate a binary image. In the binarization processing, a pixel below a predetermined luminance is replaced with a black pixel representing a foreground pixel, and a pixel equal to or higher than the predetermined luminance is replaced with a white pixel representing a background pixel. It is noted that a technique for the binarization processing of the image may be a related-art technique as long as the pixels can be converted into two gradations of white and black according to the technique.

Then, a pixel value of a pixel in the obtained pre-printed image corresponding to a pixel position determined as the black pixel in the image after the binarization is registered as the designated color of the pre-printed image.

In step S1706, the inspection processing selection unit 202 calculates the three-dimensional LUT with which the accepted designated color component can be removed.

The processing procedure of the inspection setting according to the present embodiment has been described above.

### Advantages of the Present Image Processing

According to the present embodiment, by scanning, in advance, the pre-printed sheet on which the pre-printed image is printed in advance to determine the color of the pre-printed image from the scanned image, it becomes possible for the user not to select an erroneous color as the color of the pre-printed image.

According to embodiments of the present disclosure, by removing the specific color included in the image data, the inspection on the image printed on the pre-printed sheet on which the information of the specific color is printed in advance can be correctly performed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-123787, filed Jul. 28, 2023, which is hereby incorporated by reference herein in its entirety.

What is claimed is:

1. An inspection apparatus comprising:
one or more controllers including one or more processors and one or more memories, the one or more controllers configured to cause the inspection apparatus to:
print an inspection image on a pre-printed sheet on which information of a specific color is printed in advance;
scan the pre-printed sheet on which the inspection image is printed;
remove the specific color included in a scanned image that is scanned; and
inspect, based on a reference image, the scanned image obtained after the specific color is removed.

2. The inspection apparatus according to claim 1, wherein the reference image is generated from the inspection image.

3. The inspection apparatus according to claim 1, wherein the specific color is set via a user interface.

4. The inspection apparatus according to claim 1, wherein the specific color includes a plurality of colors that are set via a user interface.

5. The inspection apparatus according to claim 1, the one or more controllers further configured to cause the inspection apparatus to:
cause a display unit to display the scanned image that is obtained when the pre-printed sheet is scanned,
wherein the specific color is set via a user interface from the image displayed on the display unit.

6. The inspection apparatus according to claim 1, the one or more controllers further configured to cause the inspection apparatus to:
obtain a color of the scanned image that is obtained when the pre-printed sheet is scanned,
wherein the specific color is the color obtained.

7. The inspection apparatus according to claim 1, wherein the one or more controllers cause the inspection apparatus to inspect, based on a result of comparison between the reference image and the image obtained after the specific color is removed, whether a defect is present or absent in the image obtained after the specific color is removed.

8. The inspection apparatus according to claim 1, wherein the reference image is an image corresponding to an image printed on the pre-printed sheet which does not include the information of the specific color.

9. A control method for an inspection apparatus, the control method comprising:
printing an inspection image on a pre-printed sheet on which information of a specific color is printed in advance;
scanning the pre-printed sheet on which the inspection image is printed in advance;
processing of removing the specific color included in a scanned image that is scanned and obtained in the scanning; and
inspecting, based on a reference image, an image obtained after the specific color is removed in the processing.

10. The control method for the inspection apparatus according to claim 9, wherein the reference image is generated from the inspection image.

11. The control method for the inspection apparatus according to claim 9, wherein the specific color is set via a user interface.

12. The control method for the inspection apparatus according to claim 9, wherein the specific color includes a plurality of colors that are set via a user interface.

13. The control method for the inspection apparatus according to claim 9, further comprising:
performing display control to cause a display unit to display the scanned and obtained image that is obtained when the pre-printed sheet is scanned in the scanning,
wherein the specific color is set via a user interface from the image displayed on the display unit.

14. The control method for the inspection apparatus according to claim 9, further comprising:
obtaining a color of the scanned and obtained image that is obtained when the pre-printed sheet is scanned in the scanning,
wherein the specific color is the color obtained in the obtaining.

15. The control method for the inspection apparatus according to claim 9, wherein in the inspecting, whether a defect is present or absent in the image obtained after the specific color is removed is inspected based on a result of comparison between the reference image and the image obtained after the specific color is removed.

16. The control method for the inspection apparatus according to claim 9, wherein the reference image is an image corresponding to an image printed on the pre-printed sheet which does not include the information of the specific color.

17. An inspection system comprising:
one or more controllers including one or more processors and one or more memories, the one or more controllers configured to cause the inspection system to:
print an inspection image on a pre-printed sheet on which information of a specific color is printed in advance;
scan the pre-printed sheet on which the inspection image is printed in advance;
remove the specific color included in a scanned image that is scanned and obtained; and
inspect, based on a reference image, the scanned image obtained after the specific color is removed.
